(19) United States
(12) Patent Application Publication
(10) Pub. No.: US 2021/0182830 A1
(43) Pub. Date: Jun. 17, 2021

(54) UTILIZING A MACHINE LEARNING MODEL TO DETERMINE WHETHER A TRANSACTION ACCOUNT USER IS TRAVELING

(71) Applicant: Capital One Services, LLC, McLean, VA (US)

(72) Inventors: Joshua EDWARDS, Philadelphia, PA (US); Michael MOSSOBA, Arlington, VA (US); Abdelkadar M'Hamed BENKREIRA, Washington, DC (US)

(21) Appl. No.: 16/712,577

(22) Filed: Dec. 12, 2019

(51) Int. Cl. G06Q 20/32; G06Q 20/40; G06N 20/00; G06K 9/62

(52) U.S. Cl. CPC G06Q 20/3224; G06Q 20/4016; G06K 9/6263; G06N 20/00; G06K 9/6257; G06Q 20/407

(57) ABSTRACT

A device may receive historical transaction data associated with transactions conducted via transaction accounts associated with users, and may receive historical travel data indicating whether the users were traveling during times associated with the transactions. The device may train a machine learning model with the historical transaction data and the historical travel data to generate a trained machine learning model, and may receive transaction data associated with transactions conducted via a transaction account associated with a user. The device may process the transaction data, with the trained machine learning model, to determine a confidence score that provides an indication of whether the user is traveling, and may determine whether the confidence score satisfies a confidence threshold. The device may determine that the user is traveling when the confidence score satisfies the confidence threshold, and may perform one or more actions based on determining that the user is traveling.

### BACKGROUND

Traveling with a transaction card or a transaction application on a user device (e.g., a smartphone) is convenient, provides a record of purchases, and is more secure than cash.

### SUMMARY

According to some implementations, a method may include receiving historical transaction data associated with transactions conducted via transaction accounts associated with users, and receiving historical travel data indicating whether the users were traveling during times associated with the transactions identified in the historical transaction data. The method may include training a machine learning model with the historical transaction data and the historical travel data to generate a trained machine learning model, and receiving transaction data associated with one or more transactions conducted via a transaction account associated with a user. The method may include processing the transaction data, with the trained machine learning model, to determine a confidence score that provides an indication of whether the user is traveling, and determining whether the confidence score satisfies a confidence threshold. The method may include determining that the user is traveling when the confidence score satisfies the confidence threshold, and performing one or more actions based on determining that the user is traveling.

According to some implementations, a device may include one or more memories, and one or more processors, communicatively coupled to the one or more memories, to receive transaction data associated with one or more transactions conducted via a transaction account associated with a user, and process the transaction data, with a machine learning model, to determine a confidence score that provides an indication of whether the user is traveling. The machine learning model may be trained based on historical transaction data associated with transactions conducted via transaction accounts associated with users, and historical travel data indicating whether the users are traveling during times associated with the transactions identified in the historical transaction data. The one or more processors may determine whether the confidence score satisfies a confidence threshold, and may determine that the user is traveling, when the confidence score satisfies the confidence threshold. The one or more processors may perform one or more actions based on determining that the user is traveling.

According to some implementations, a non-transitory computer-readable medium may store one or more instructions that, when executed by one or more processors of a device, may cause the one or more processors to receive historical transaction data associated with transactions conducted via transaction accounts associated with users, and receive historical travel data indicating whether the users were traveling during times associated with the transactions identified in the historical transaction data. The one or more instructions may cause the one or more processors to train a machine learning model with the historical transaction data and the historical travel data to generate a trained machine learning model, and receive transaction data associated with one or more transactions conducted via a transaction account associated with a user. The one or more instructions may cause the one or more processors to process the transaction data, with the trained machine learning model, to determine a confidence score that provides an indication of whether the user is traveling, and determine whether the confidence score satisfies a confidence threshold. The one or more instructions may cause the one or more processors to determine that the user is traveling, when the confidence score satisfies the confidence threshold, and provide, to a user device associated with the user, a notification requesting a response indicating whether the user is traveling, when the confidence score fails to satisfy the confidence threshold. The one or more instructions may cause the one or more processors to receive, from the user device and based on the notification, the response indicating whether the user is traveling, and perform one or more actions based on determining that the user is traveling or when the response indicates that the user is traveling.

### BRIEF DESCRIPTION OF THE DRAWINGS

FIGS. 1A-1H are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for utilizing a machine learning model to determine whether a transaction account user is traveling.

### DETAILED DESCRIPTION

The following detailed description of example implementations refers to the accompanying drawings. The same reference numbers in different drawings may identify the same or similar elements.

A user that is traveling has many things to take care of, such as packing, planning flights, planning a rental car, planning hotel accommodations, and/or the like. However, if the user is traveling on a trip with a transaction card or a transaction application, the user should notify a transaction card issuer (e.g., a financial institution) about the trip to ensure that any transactions made using the transaction card or the transaction application do not get declined for suspected fraud. Mistakenly declining valid transactions wastes computing resources (e.g., processing resources, memory resources, and/or the like), networking resources, and/or the like associated with conducting transactions that will be declined due to suspected fraud, contacting a financial institution while traveling about the declined transactions, associating a travel indicator with the transaction account, reconducting the declined transactions before and/or after the travel indicator is associated with the transaction account, and/or the like.

Some implementations described herein provide a travel prediction platform that utilizes a machine learning model to determine whether a transaction account user is traveling. For example, the travel prediction platform may receive historical transaction data associated with transactions conducted via transaction accounts associated with users, and may receive historical travel data indicating whether the users were traveling during times associated with the transactions identified in the historical transaction data. The travel prediction platform may train a machine learning model with the historical transaction data and the historical travel data to generate a trained machine learning model, and may receive transaction data associated with one or more transactions conducted via a transaction account associated with a user. The travel prediction platform may process the transaction data, with the trained machine learning model, to determine a confidence score that provides an indication of whether the user is traveling, and may determine whether the confidence score satisfies a confidence threshold. The travel prediction platform may determine that the user is traveling when the confidence score satisfies the confidence threshold, and may perform one or more actions based on determining that the user is traveling.

In this way, the travel prediction platform enables a user of a transaction account to indirectly inform a financial institution about traveling on a trip, so that a travel indicator is associated with the transaction account during the trip and that transactions during the trip are not declined due to suspected fraud. This prevents waste of computing resources (e.g., processing resources, memory resources, and/or the like), networking resources, and/or the like associated with conducting transactions that will be declined due to suspected fraud, contacting a financial institution while traveling about the declined transactions, associating a travel indicator with the transaction account, reconducting the declined transactions before and/or after the travel indicator is associated with the transaction account, and/or the like.

The travel prediction platform also conserves resources that would otherwise be used by a user to provide a travel notification to a financial institute (e.g., resources associated with making a telephone call, waiting on hold, informing a financial institute employee, the employee entering a travel indicator for the user's transaction account, and repeating this for every account that might be used while the user is traveling). The travel prediction platform may conserve resources associated with when a user is not traveling but a financial institution fails to flag a transaction as fraudulent (e.g., computing, communication, and network resources are wasted in reporting, identifying, investigating, and resolving the fraud).

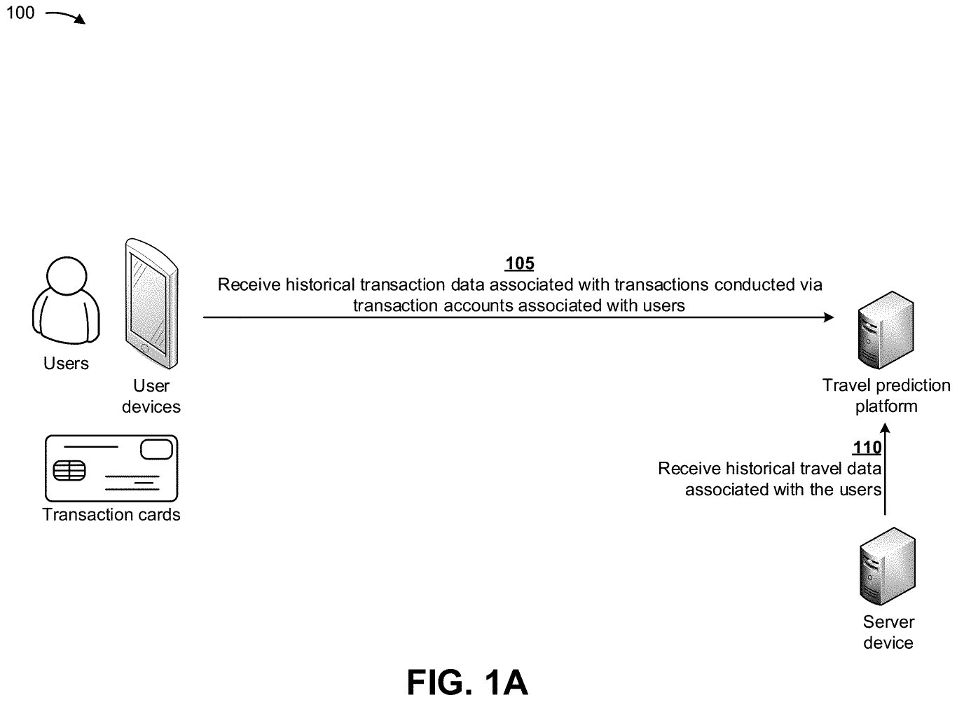

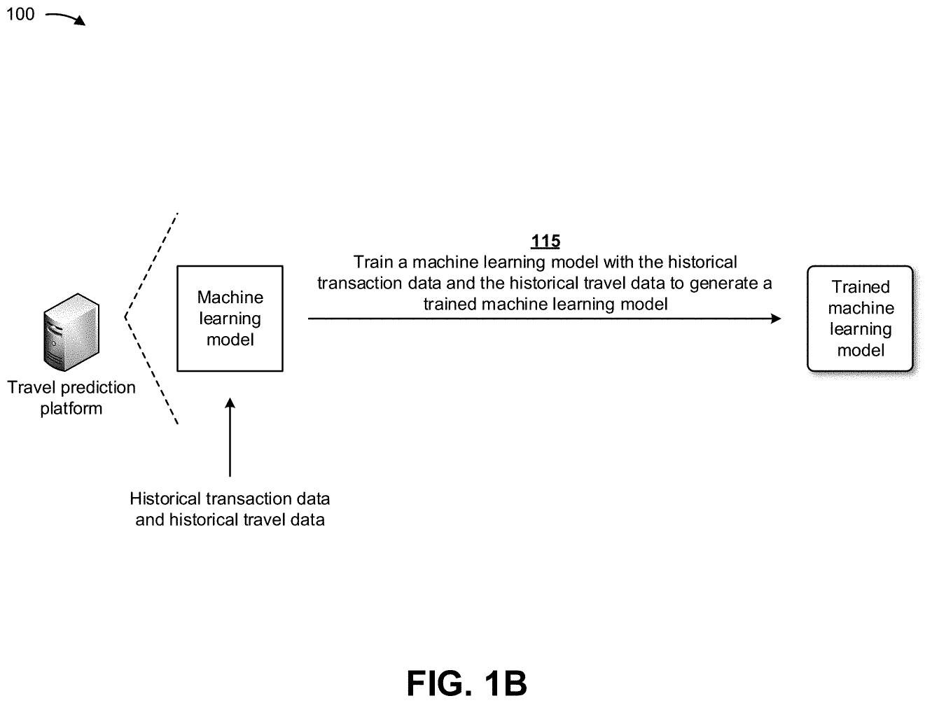

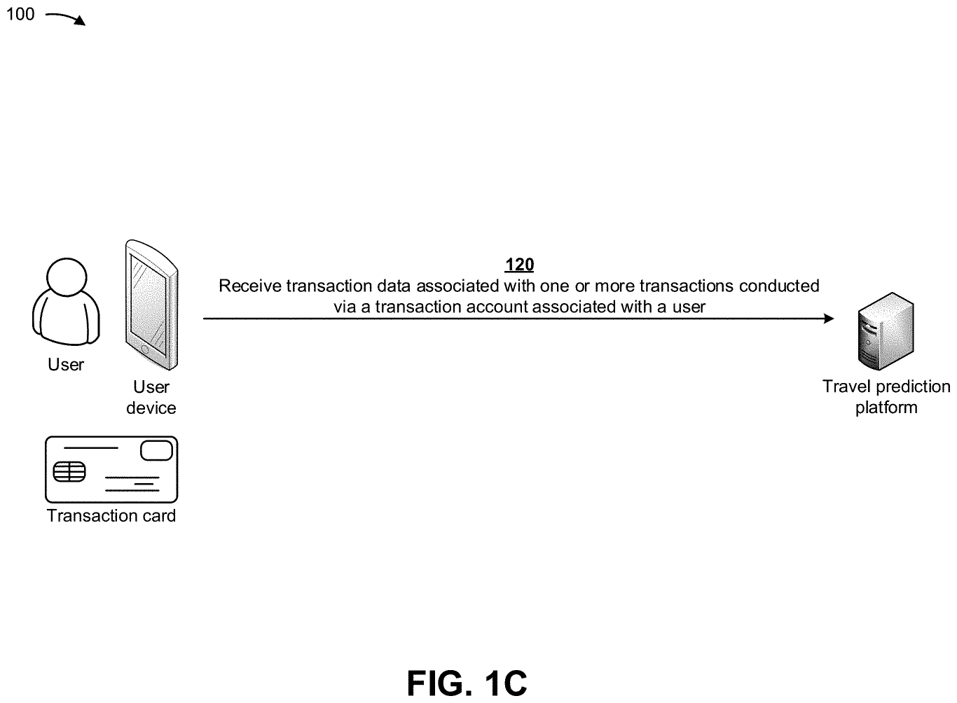

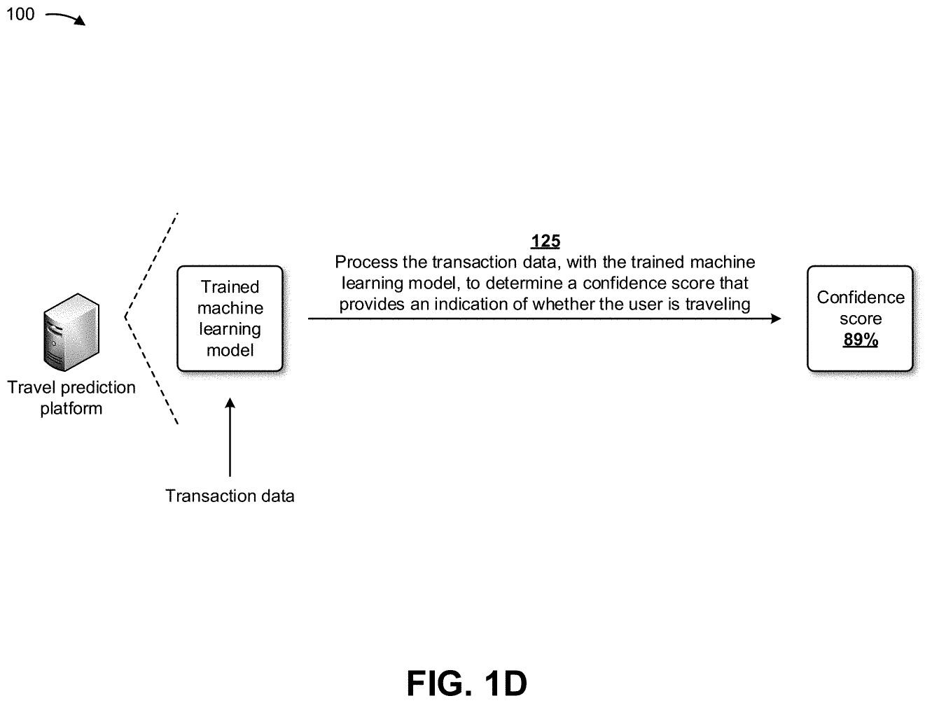

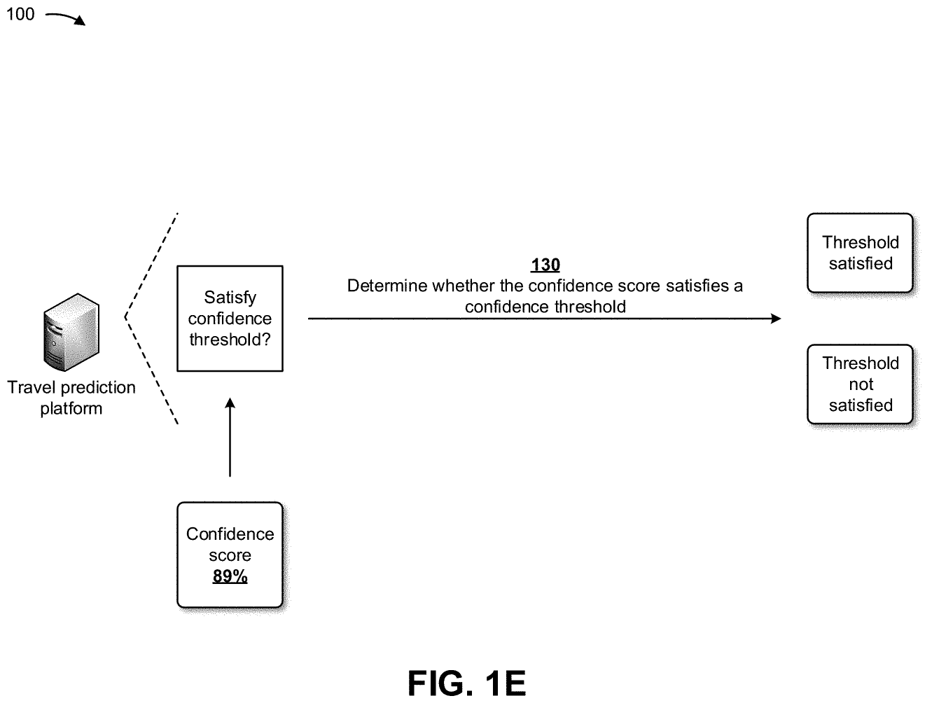

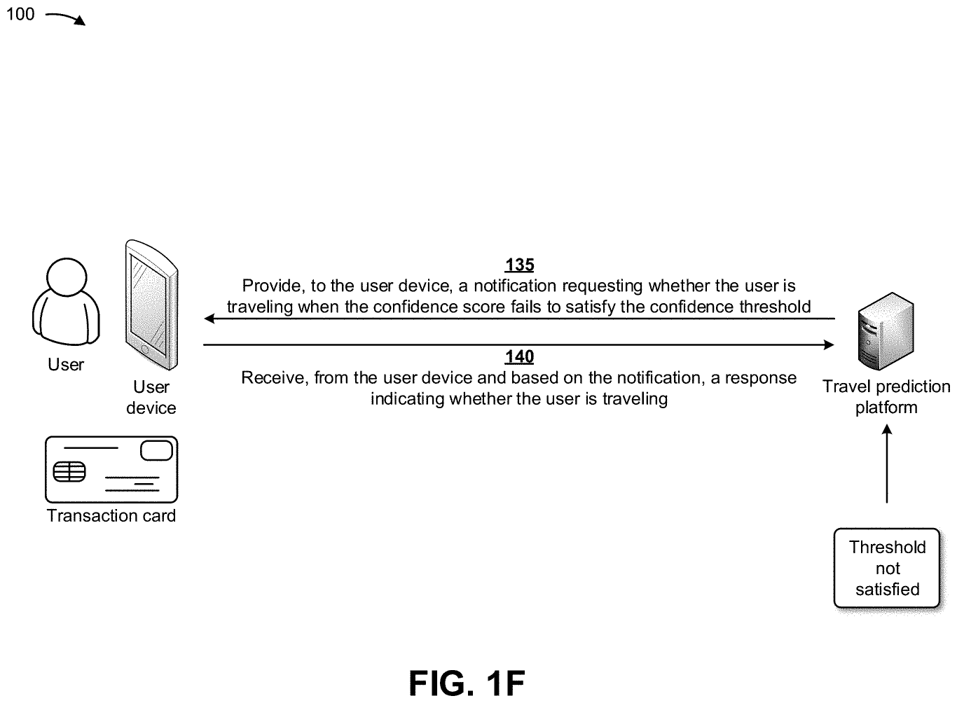

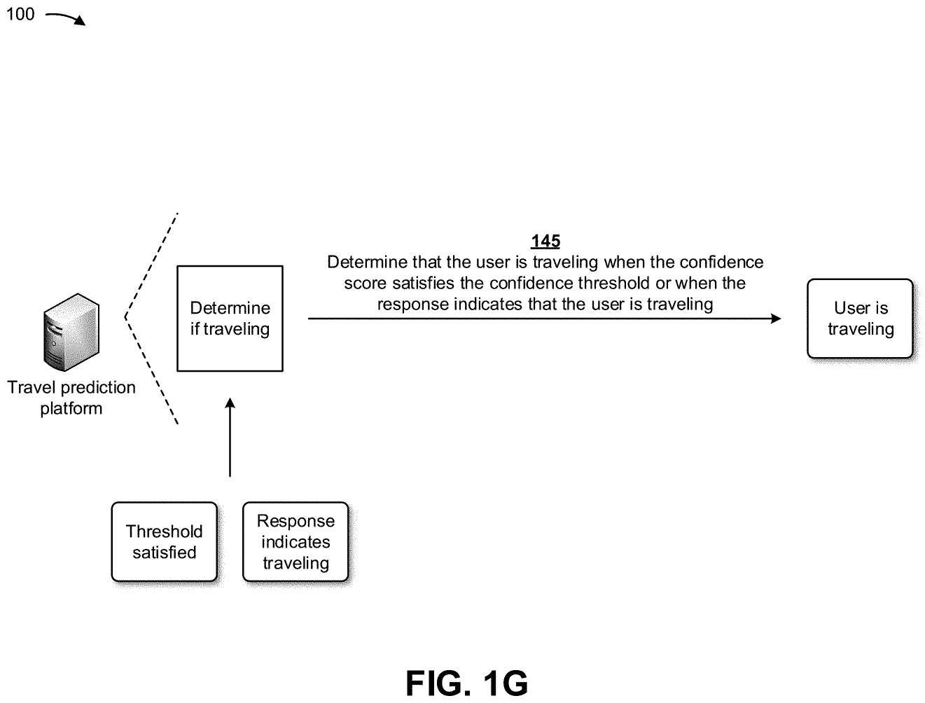

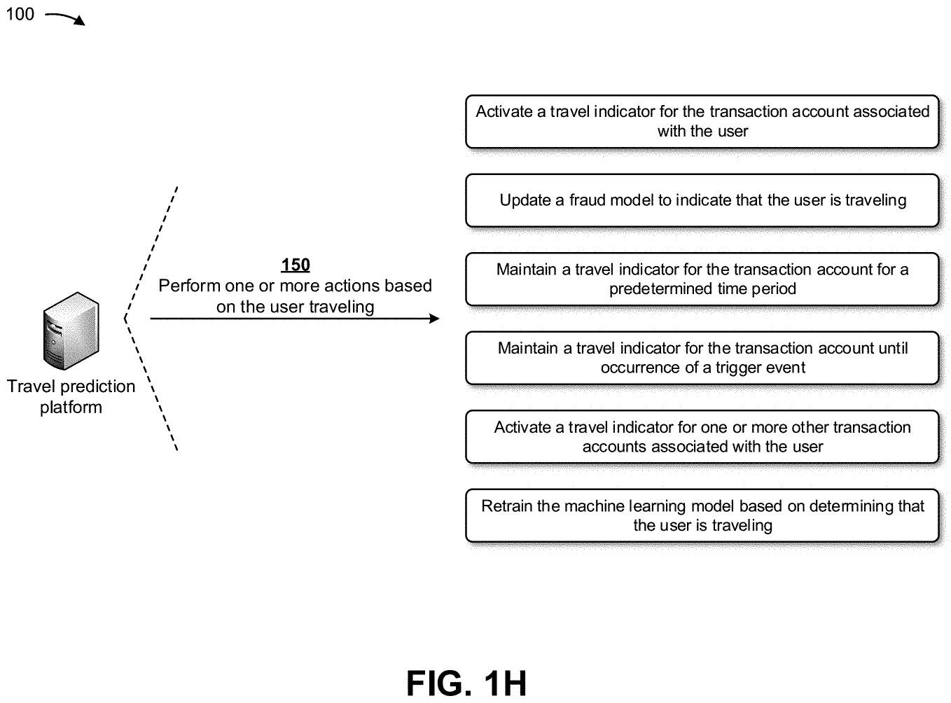

FIGS. 1A-1H are diagrams of one or more example implementations 100 described herein. As shown in FIG. 1A, user devices, transaction cards, and a server device may be associated with a travel prediction platform. As further shown, the user devices and the transaction cards may be associated with users that conduct transactions with the user devices (e.g., via transaction applications associated with accounts of the users) or the transaction cards associated with the accounts. The server device may be associated with merchants, financial institutions (e.g., banks), and/or the like, that may receive and/or store information associated with travel conducted by the users.

As further shown in FIG. 1A, and by reference number 105, the travel prediction platform may receive, from the user devices and/or the transaction cards, historical transaction data associated with transactions conducted via transaction accounts (e.g., financial accounts, such as bank accounts, credit accounts, debit accounts, and/or the like) associated with the users. In some implementations, the travel prediction platform may periodically receive the historical transaction data, may continuously receive the historical transaction data, may receive the historical transaction data based on a request, and/or the like. The travel prediction platform may store the historical transaction data in a data structure (e.g., a database, a list, a table, and/or the like) associated with the travel prediction platform. In some implementations, the travel prediction platform may receive the historical transaction data from the server device.

In some implementations, the historical transaction data may include data identifying one or more transactions associated with purchases at or near airports, train stations, bus stations, ports, and/or the like. For example, the one or more transactions may be associated with paying for baggage fees at an airport with a transaction card, buying items (e.g., snacks) from train station vendors, and/or the like. In some implementations, the historical transaction data may differentiate purchase-related data based on whether purchases were made from vendors located within areas restricted to travelers (e.g., beyond transportation security administration (TSA) screening locations), from vendors located outside areas restricted to travelers, and/or the like. In this way, the historical transaction data may distinguish between purchasers who are likely to be traveling (e.g., on a flight) and purchasers who may be located at a travel-related location (e.g., an airport) for other reasons (e.g., to drop off a traveler and are not traveling). By limiting the data provided, the travel prediction platform may conserve communication and network resources that would otherwise be used to transmit a larger data set (e.g., all of the historical transaction data).

The historical transaction data may include data identifying one or more transactions associated with purchasing airline tickets, train tickets, bus tickets, cruise tickets, and/or the like. In this case, the historical transaction data may include additional transactional data (e.g., flight data that includes travel dates and travel locations) that may identify destinations, departure dates and times to the destinations, return dates and times from the destinations, and/or the like. The historical transaction data may include data identifying one or more transactions associated with checking in at airports (e.g., using a credit card to check in at an airport terminal), train stations, bus stations, ports, etc.; data identifying one or more transactions associated with currency exchange at airports, train stations, bus stations, ports, etc.; data identifying one or more transactions associated with purchases made at gas stations (e.g., near an international border), rest stops, turnpike stops, etc.; data identifying one or more transactions associated with withdrawing funds from automated teller machines located at airports, rest stops, train stations, bus stations, ports, etc.; data identifying one or more transactions associated with purchases made during travel (e.g., purchases of food or drink on airplanes, trains, buses, ships, etc., in-flight wireless access purchases on airplanes, and/or the like); data identifying one or more transactions associated with lodging facilities such as hotels, motels, bed and breakfasts, etc. (e.g., for checking into lodging facilities, checking out of lodging facilities, purchasing goods and services provided at lodging facilities, etc.); and/or the like.

In some implementations, the user devices and/or the transaction cards may be configured to identify particular types of data as the historical transaction data, and may provide the particular types of data to the travel prediction platform when identified. The user devices and/or the transaction cards may identify the particular types of data, particular merchants, transactions at particular locations, and/or the like as a trigger to collect and send the historical transaction data to the travel prediction platform.

As further shown in FIG. 1A, and by reference number 110, the travel prediction platform may receive, from the server device, historical travel data associated with the users. In some implementations, the travel prediction platform may periodically receive the historical travel data, may continuously receive the historical travel data, may receive the historical travel data based on a request, and/or the like. The travel prediction platform may store historical travel data in a data structure associated with the travel prediction platform. In some implementations, the server device may be configured to identify particular types of data as the historical travel data, and may provide the particular types of data to the travel prediction platform when identified. The server device may identify the particular types of data, particular travel data, transactions at particular locations, and/or the like as a trigger to collect and send the historical travel data to the travel prediction platform.

In some implementations, the historical travel data may include data identifying airline travel itineraries associated with the users, train travel itineraries associated with the users, bus travel itineraries associated with the users, cruise ship itineraries associated with the users, lodging accommodations associated with the users, rental car agreements associated with the users, and/or the like. The historical travel data may include data associated with online booking services for booking flights, train trips, hotel rooms, rental cars, and/or the like. In some implementations, the historical travel data may be based on information obtained from software applications (e.g., provided on the user devices by the server device), such as online travel booking applications, calendar applications, email applications, text message applications, voice mail applications, Internet browsing histories, browser add-ons, installed applications, and/or the like.

In some implementations, there may be hundreds, thousands, and/or the like, of user devices and/or server devices that produce thousands, millions, billions, and/or the like, of data points provided in the historical transaction data and/or the historical travel data. In this way, the travel prediction platform may handle thousands, millions, billions, and/or the like, of data points within a period of time (e.g., daily, weekly, monthly), and thus may provide “big data” capability.

As shown in FIG. 1B, and by reference number 115, the travel prediction platform may train a machine learning model with the historical transaction data and the historical travel data to generate a trained machine learning model. For example, the machine learning model may be trained to identify transactions, identify patterns in transactions, and/or the like that may be associated with travel; to determine a likelihood that the transactions, patterns in transactions, and/or the like are associated with travel; and/or the like. The trained machine learning model may be used to process transaction data to determine a confidence score that provides an indication of whether a user is traveling, as described herein.

In some implementations, the machine learning model may include a clustering model, such as k-means clustering model, a mean-shift clustering model, a density-based spatial clustering of applications with noise (DBSCAN) model, an expectation-maximization (EM) clustering using Gaussian mixture model (GMM), an agglomerative hierarchical clustering model, and/or the like. In some implementations, the machine learning model may classify transactions into specific groups (e.g., where a group is associated with a particular location, a type of transaction, a type of transportation, a date range, and/or the like) based on the historical transaction data and the historical travel data.

In some implementations, the travel prediction platform may separate the historical transaction data and the historical travel data into a training set, a validation set, a test set, and/or the like. The training set may be utilized to train the machine learning model to determine (e.g., based on transaction data) a confidence score that provides an indication of whether a user is traveling. The validation set may be utilized to validate results of the trained machine learning model. The test set may be utilized to test operation of the trained machine learning model.

In some implementations, the travel prediction platform may train the machine learning model using, for example, an unsupervised training procedure and based on the historical transaction data and the historical travel data. For example, the travel prediction platform may perform dimensionality reduction to reduce the historical transaction data and the historical travel data to a minimum feature set, thereby reducing resources (e.g., processing resources, memory resources, and/or the like) needed to train the machine learning model, and may apply a classification technique to the minimum feature set.

In some implementations, the travel prediction platform may use a logistic regression classification technique to determine a categorical outcome (e.g., whether transaction data indicates a likelihood that a user is traveling). Additionally, or alternatively, the travel prediction platform may use a naive Bayesian classifier technique. In this case, the travel prediction platform may perform binary recursive partitioning to split the historical transaction data and the historical travel data into partitions and/or branches and use the partitions and/or branches to determine outcomes (e.g., whether transaction data indicates a likelihood that a user is traveling). Based on using recursive partitioning, the travel prediction platform may reduce utilization of computing resources relative to manual, linear sorting and analysis of data points, thereby enabling use of thousands, millions, or billions of data points to train the machine learning model, which may result in more accurate models than using fewer data points.

Additionally, or alternatively, the travel prediction platform may use a support vector machine (SVM) classifier technique to generate a non-linear boundary between data points in the training set. In this case, the non-linear boundary is used to classify test data into a particular class.

Additionally, or alternatively, the travel prediction platform may train the machine learning model using a supervised training procedure that includes receiving input to the machine learning model from a subject matter expert, which may reduce an amount of time, an amount of processing resources, and/or the like to train the machine learning model relative to an unsupervised training procedure. In some implementations, the travel prediction platform may use one or more other model training techniques, such as a neural network technique, a latent semantic indexing technique, and/or the like. For example, the travel prediction platform may perform an artificial neural network processing technique (e.g., using a two-layer feedforward neural network architecture, a three-layer feedforward neural network architecture, and/or the like) to perform pattern recognition with regard to patterns of the historical transaction data and the historical travel data. In this case, using the artificial neural network processing technique may improve an accuracy of the trained machine learning model generated by the travel prediction platform by being more robust to noisy, imprecise, or incomplete data, and by enabling the travel prediction platform to detect patterns and/or trends undetectable to human analysts or systems using less complex techniques.

In some implementations, rather than training the machine learning model, the travel prediction platform may receive a trained machine learning model from another device (e.g., a server device). For example, a server device may generate a trained machine learning model based on having trained a machine learning model in a manner similar to that described above, and may provide the trained machine learning model to the travel prediction platform (e.g., may pre-load the travel prediction platform with the trained machine learning model, may receive a request from the travel prediction platform for the trained machine learning model, and/or the like).

As shown in FIG. 1C, and by reference number 120, the travel prediction platform may receive transaction data associated with one or more transactions conducted via a transaction account associated with a user. In some implementations, the travel prediction platform may receive the transaction data from a user device associated with the user, from a device to which a transaction card (e.g., a credit card, a debit card, a rewards card, a prepaid card, and/or the like) of the user or the user device is provided (e.g., a point of sale device, a payment terminal, an automated teller machine, and/or the like), a server device associated with the transaction account, and/or the like. The travel prediction platform may receive the transaction data in near real time with respect to the one or more transactions conducted via the transaction account.

In some implementations, the transaction account may include a financial account, such as a bank account, a credit card account, a debit card account, a rewards card account, a prepaid card account, and/or the like. The transaction account may be associated with (e.g., registered to, available to, and/or the like) the user to permit the user to engage in transactions via the transaction account (e.g., by using funds associated with the transaction account). The transaction data may be associated with a transaction account of a single user; with a transaction account of multiple related users (e.g., a husband and a wife, a parent or guardian and a child, and/or the like); with a single transaction account; with multiple related transaction accounts (e.g., associated with a single user or multiple related users); with different types of accounts (e.g., a credit account, a debit account, a bank account, and/or the like) of a single user or multiple related users; and/or the like.

As shown in FIG. 1D, and by reference number 125, the travel prediction platform may process the transaction data, with the trained machine learning model, to determine a confidence score that provides an indication of whether the user is traveling. For example, a confidence score of 89% (as shown in FIG. 1D) may indicate an 89% probability that the user is traveling. The trained machine learning model may identify transactions, may identify patterns in transactions, and/or the like that may be associated with travel; may determine a likelihood that the transactions, the patterns in the transactions, and/or the like are associated with travel; may determine the confidence score based on the likelihood that the transactions, the patterns in the transactions, and/or the like are associated with travel; and/or the like. For example, if the transaction data indicates a purchase near the user's home, the trained machine learning model may assign a low confidence score (e.g., five percent, ten percent, and/or the like) to such a purchase to indicate a low likelihood that the user is traveling. In another example, if the transaction data indicates a purchase within an airport terminal beyond a TSA checkpoint, the trained machine learning model may assign a high confidence score (e.g., seventy-five percent, eighty percent, and/or the like) to such a purchase to indicate a high likelihood that the user is traveling. In some implementations, the trained machine learning model may predict, if the user is traveling, a destination to which the user is traveling.

In some implementations, the travel prediction platform may determine whether the transaction associated with the transaction data is a potential travel-related transaction, and may not process the transaction data with the trained machine learning model if the transaction is not determined to be a potential travel-related transaction. For example, the travel prediction platform may determine that the transaction is not a potential travel-related transaction if the transaction occurs near (e.g., within a distance, radius, or a travel distance of) a home of the user, a location regularly frequented by the user, a work location of the user, and/or the like; if the transaction does not involve a transportation service (e.g., an airline service, a train service, a bus service, a cruise service, and/or the like) or a service (e.g., a travel booking service) or facility (e.g., an airport, a train station, a bus station, and/or the like) associated with a transportation service; and/or the like. In this way, the travel prediction platform may prevent transactions that may be quickly determined to be unrelated to travel from being processed by the trained machine learning model, which conserves resources that would otherwise be used to process data related to travel and data unrelated to travel.

As shown in FIG. 1E, and by reference number 130, the travel prediction platform may determine whether the confidence score satisfies a confidence threshold. For example, if the confidence threshold is 85%, the travel predication platform may determine that the confidence score, determined by the trained machine learning model (e.g., 89%), satisfies the confidence threshold. In some implementations, the trained machine learning model may determine an indication of whether a user is traveling in other ways. For example, the trained machine learning model may determine multiple confidence scores associated with one or more transactions, associated with multiple different users related to the transaction account, associated with multiple different transaction accounts related to the user, and/or the like. In this case, the travel prediction platform may determine whether the multiple confidence scores satisfy a confidence threshold, such as based on an average of the multiple confidence scores, a weighted average of the multiple confidence scores, a combination of the multiple confidence scores, and/or the like.

As shown in FIG. 1F, and by reference number 135, the travel prediction platform may provide, to the user device, a notification requesting whether the user is traveling when the confidence score fails to satisfy the confidence threshold. For example, the notification may request a response (e.g., from the user device) indicating whether the user is traveling, based on determining that the confidence score fails to satisfy the confidence threshold. In some implementations, the travel prediction platform may provide the notification to the user device via a transaction account application (e.g., a banking application) installed on the user device, via a text message, via an email message, via an automated telephone call, and/or the like. The travel prediction platform may provide the notification in near real time relative to processing the transaction data with the trained machine learning model, relative to determining whether the confidence score satisfies the confidence threshold, and/or the like.

As further shown in FIG. 1F, and by reference number 140, the travel prediction platform may receive, from the user device and based on the notification, a response indicating whether the user is traveling. For example, the travel prediction platform may receive the response from the user device via a transaction account application installed on the user device, via a text message, via an email message, via an automated telephone call, and/or the like.

In some implementations, instead of providing a notification to the user device, the travel prediction platform may consider data associated with one or more other transactions to determine whether the user is traveling. For example, the travel prediction platform may determine that the user is traveling if the user uses the transaction card or the user device to check into a hotel; if the user uses the transaction card or the user device to purchase wireless access on an airplane; if the user uses the transaction card or the user device to perform a currency exchange at an airport; if the user uses the transaction card or the user device to purchase an item at a travel-related location (e.g., an airport, a rest stop, a train station, and/or the like); if the user device has been placed into a travel-related mode such as an airplane mode; and/or the like.

As shown in FIG. 1G, and by reference number 145, the travel prediction platform may determine that the user is traveling when the confidence score satisfies the confidence threshold or when the response indicates that the user is traveling. This may enable the travel prediction platform to cause the transaction account to be handled differently than when the user is not determined to be traveling. For example, future transactions associated with the transaction account may not be declined due to suspected fraud, a fraud alert may not be invoked, and/or the like.

In some implementations, when the confidence score fails to satisfy the confidence threshold and the response indicates that the user is not traveling, the travel prediction platform may determine that the user is not traveling. This may enable the travel prediction platform to cause the transaction account to be handled as if the user is not traveling. For example, the transaction and future transactions associated with transaction account may be declined due to suspected fraud, a fraud alert may be invoked, and/or the like.

In some implementations, when the confidence score fails to satisfy the confidence threshold, the travel prediction platform may not provide, to the user device, the notification requesting whether the user is traveling, but may automatically determine that the user is not traveling. For example, the confidence threshold may be an upper confidence threshold and a lower confidence threshold (e.g., less than twenty percent, ten percent, and/or the like) may be established. If the confidence score fails to satisfy the lower confidence threshold, the travel prediction platform may automatically determine that the user is not traveling. In some implementations, if the user is not traveling, the travel prediction platform may prevent activation of a travel indicator for the transaction account associated with the user. The travel indicator may indicate (e.g., to a fraud model) that the user is traveling. The travel prediction platform may prevent activation of the travel indicator in near real-time relative to determining that the user not traveling. If the travel prediction platform receives additional transaction data indicating an additional transaction conducted via the transaction account, the travel prediction platform may prevent the additional transaction, via the fraud model, based on preventing activation of the travel indicator and because the additional transaction occurred a particular distance from a home of the user (e.g., in another country, another city, and/or the like).

As shown in FIG. 1H, and by reference number 150, the travel prediction platform may perform one or more actions based on determining that the user is traveling. The one or more actions may include the travel prediction platform activating a travel indicator for the transaction account associated with the user. The travel prediction platform may activate the travel indicator in near real-time relative to determining that the user is traveling. In this way, the travel prediction platform may enable a financial institution to automatically adjust how transactions are handled when the user is determined to be traveling, which may improve speed and efficiency of processes that are affected by the travel status of the user, and conserve computing resources (e.g., processing resources, memory resources, and/or the like), communication resources, networking resources, and/or the like that would otherwise be used to mistakenly decline a transaction, communicate about a mistakenly declined transaction, retry a mistakenly declined transaction, approve a mistakenly decline transaction, and/or the like.

As further shown in FIG. 1H, the one or more actions may include the travel prediction platform updating a fraud model to indicate that the user is traveling. For example, if the travel prediction platform determines that the user is traveling (e.g., the confidence score satisfies the confidence threshold), the travel prediction platform may activate the travel indicator for the transaction account associated with the user. If the travel prediction platform receives additional transaction data indicating an additional transaction conducted via the transaction account associated with the user, the travel prediction platform may prevent the fraud model from preventing the additional transaction based on activation of the travel indicator. In this way, if the user is determined to be traveling, the travel prediction platform prevents transactions from being declined due to suspected fraud. This prevents waste of computing resources, networking resources, and/or the like associated with conducting transactions that would otherwise be declined due to suspected fraud, contacting a financial institution while traveling about the declined transactions, associating a travel indicator with the transaction account, reconducting the declined transactions after the travel indicator is associated with the transaction account, and/or the like.

As further shown in FIG. 1H, the one or more actions may include the travel prediction platform maintaining a travel indicator for the transaction account for a predetermined time period. For example, the travel prediction platform may activate the travel indicator for the transaction account associated with the user, may maintain the travel indicator for a predetermined time period, and may deactivate the travel indicator for the transaction account after the predetermined time period. In some implementations, the predetermined time period may be based on a default value (e.g., in days, a date, and/or the like), may be specified by a financial institution, may be adjustable (e.g., by the user, a transaction card issuer, and/or the like), and/or the like. In this way, the travel prediction platform may prevent transactions from being declined due to suspected fraud while the user is traveling, and may increase the chances of protecting against fraudulent transactions that may occur after the user is no longer traveling. This may protect the user and a financial institution associated with the transaction account from financial loss, and may conserve computing resources, networking resources, and/or the like, that would be wasted investigating and handling fraudulent transactions.

As further shown in FIG. 1H, the one or more actions may include the travel prediction platform maintaining a travel indicator for the transaction account until occurrence of a trigger event. For example, the travel prediction platform may activate the travel indicator for the transaction account associated with the user, may maintain the travel indicator until occurrence of a trigger event (e.g., an event that indicates that the user is not traveling), and may deactivate the travel indicator for the transaction account after the occurrence of the trigger event. In some implementations, the trigger event may include use of the transaction card near a home location of the user, returning a rental car, and/or the like. In this way, the travel prediction platform may prevent transactions from being declined due to suspected fraud while the user is traveling, and may increase the chances of protecting against fraudulent transactions that may occur after the user is no longer traveling.

In some implementations, the travel prediction platform may activate the travel indicator for the transaction account associated with the user, and may maintain the travel indicator until the occurrence of a trigger event or until expiration of a predetermined time period, whichever comes first.

As further shown in FIG. 1H, the one or more actions may include the travel prediction platform activating a travel indicator for one or more other transaction accounts associated with the user. For example, the travel prediction platform may activate the travel indicator for a first transaction account associated with the user, and may activate the travel indicator for a second transaction account associated with user. As another example, the travel indicator may be associated with one or more transaction accounts of multiple related users (e.g., a husband and wife, a parent or guardian and child, and/or the like), and/or the like, and the travel prediction platform may activate the travel indicator for the one or more transaction accounts of the multiple related users. In this way, upon determining that the user is traveling, the travel prediction platform may prevent transactions associated with other accounts of the user from being declined due to suspected fraud, thereby preventing waste of computing resources, networking resources, and/or the like associated with declined transactions.

As further shown in FIG. 1H, the one or more actions may include the travel prediction platform retraining the machine learning model based on determining that the user is traveling. For example, the travel prediction platform may retrain the machine learning model based on the confidence score satisfying the confidence threshold, based on the response indicating that the user is traveling, and/or the like. In this way, the travel prediction platform may improve the accuracy of the machine learning model in determining the confidence score indicating whether the user is traveling, which may improve speed and efficiency of the machine learning model and conserve computing resources, networking resources, and/or the like.

In some implementations, the travel prediction platform may handle multiple transaction accounts of a user with different organizations and may determine which organizations to notify about the travel indicator (e.g., based on past travel of the user, the travel prediction platform may determine that the user typically uses card X, card Y, and account Z when traveling). In some implementations, when the travel prediction platform determines that a user is traveling, the travel prediction platform may recommend cards and/or accounts to utilize (e.g., with a greatest benefit to a user, such as not foreign transaction fees), may inform institutions associated with the recommended cards and/or accounts about the user traveling, and/or the like.

In this way, several different stages of the process for determining whether a transaction account user is traveling are automated via machine learning, which may remove human subjectivity and waste from the process, and which may improve speed and efficiency of the process and conserve computing resources (e.g., processing resources, memory resources, and/or the like), networking resources, and/or the like. Furthermore, implementations described herein use a rigorous, computerized process to perform tasks or roles that were not previously performed or were previously performed using subjective human intuition or input. For example, currently there does not exist a technique that utilizes a machine learning model to determine whether a transaction account user is traveling. Finally, the process for utilizing a machine learning model to determine whether a transaction account user is traveling conserves computing resources, networking resources, and/or the like that would otherwise be wasted by conducting transactions that will be declined due to suspected fraud, contacting a financial institution while traveling about the declined transactions, associating a travel indicator with the transaction account, reconducting the declined transactions after the travel indicator is associated with the transaction account, and/or the like.

As indicated above, FIGS. 1A-1H are provided merely as examples. Other examples may differ from what is described with regard to FIGS. 1A-1H.

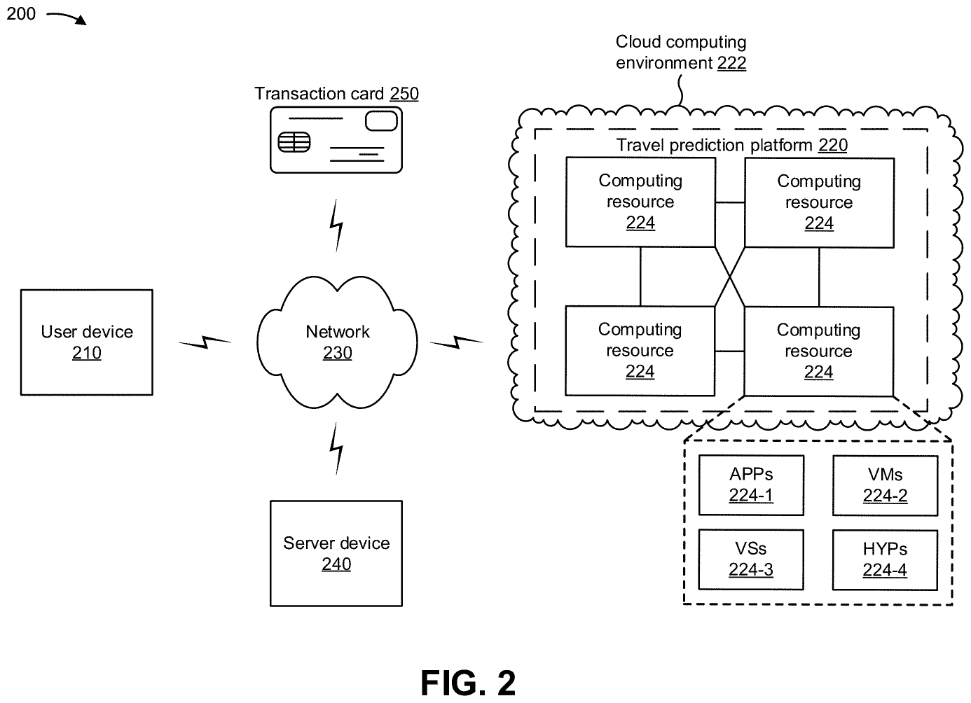

FIG. 2 is a diagram of an example environment 200 in which systems and/or methods described herein may be implemented. As shown in FIG. 2, environment 200 may include a user device 210, a travel prediction platform 220, a network 230, a server device 240, and a transaction card 250. Devices of environment 200 may interconnect via wired connections, wireless connections, or a combination of wired and wireless connections.

User device 210 includes one or more devices capable of receiving, generating, storing, processing, and/or providing information, such as information described herein. For example, user device 210 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), a camera (e.g., a security camera, a closed-circuit television (CCTV) camera, a smart camera, a satellite camera, etc.), or a similar type of device. In some implementations, user device 210 may receive information from and/or transmit information to travel prediction platform 220 and/or server device 240.

Travel prediction platform 220 includes one or more devices that may utilize a machine learning model to determine whether a transaction account user is traveling. In some implementations, travel prediction platform 220 may be modular such that certain software components may be swapped in or out depending on a particular need. As such, travel prediction platform 220 may be easily and/or quickly reconfigured for different uses. In some implementations, travel prediction platform 220 may receive information from and/or transmit information to one or more user devices 210 and/or server devices 240.

In some implementations, as shown, travel prediction platform 220 may be hosted in a cloud computing environment 222. Notably, while implementations described herein describe travel prediction platform 220 as being hosted in cloud computing environment 222, in some implementations, travel prediction platform 220 may be non-cloud-based (i.e., may be implemented outside of a cloud computing environment) or may be partially cloud-based.

Cloud computing environment 222 includes an environment that may host travel prediction platform 220. Cloud computing environment 222 may provide computation, software, data access, storage, etc. services that do not require end-user knowledge of a physical location and configuration of system(s) and/or device(s) that host travel prediction platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host travel prediction platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by user device 210. Application 224-1 may eliminate a need to install and execute the software applications on user device 210. For example, application 224-1 may include software associated with travel prediction platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program and may support a single process. In some implementations, virtual machine 224-2 may execute on behalf of a user (e.g., a user of user device 210 or an operator of travel prediction platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may provide administrators of the storage system with flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

Server device 240 includes one or more devices capable of receiving, generating, storing, processing, and/or providing information, such as information described herein. For example, server device 240 may include a laptop computer, a tablet computer, a desktop computer, a group of server devices, or a similar type of device, associated with a government agency, a financial institution, a social service organization, and/or the like. In some implementations, server device 240 may receive information from and/or transmit information to user device 210 and/or travel prediction platform 220.

Transaction card 250 includes a transaction card that can be used to complete a transaction. For example, transaction card 250 may include a credit card, a debit card, a gift card, a payment card, an automated teller machine (ATM) card, a stored-value card, a fleet card, a room or building access card, a driver's license card, and/or the like. Transaction card 250 may be capable of storing and/or communicating data for a point-of-sale (PoS) transaction with a transaction terminal. For example, transaction card 250 may store and/or communicate data, including account information (e.g., an account identifier, a cardholder identifier, etc.), expiration information of transaction card 250 (e.g., information identifying an expiration month and/or year of transaction card 250), banking information (e.g., a routing number of a bank, a bank identifier, etc.), transaction information (e.g., a payment token), and/or the like. For example, to store and/or communicate the data, transaction card 250 may include a magnetic strip and/or an integrated circuit (IC) chip.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device and/or a single device shown in FIG. 2 may be implemented as multiple, distributed devices. Additionally, or alternatively, a set of devices (e.g., one or more devices) of environment 200 may perform one or more functions described as being performed by another set of devices of environment 200.

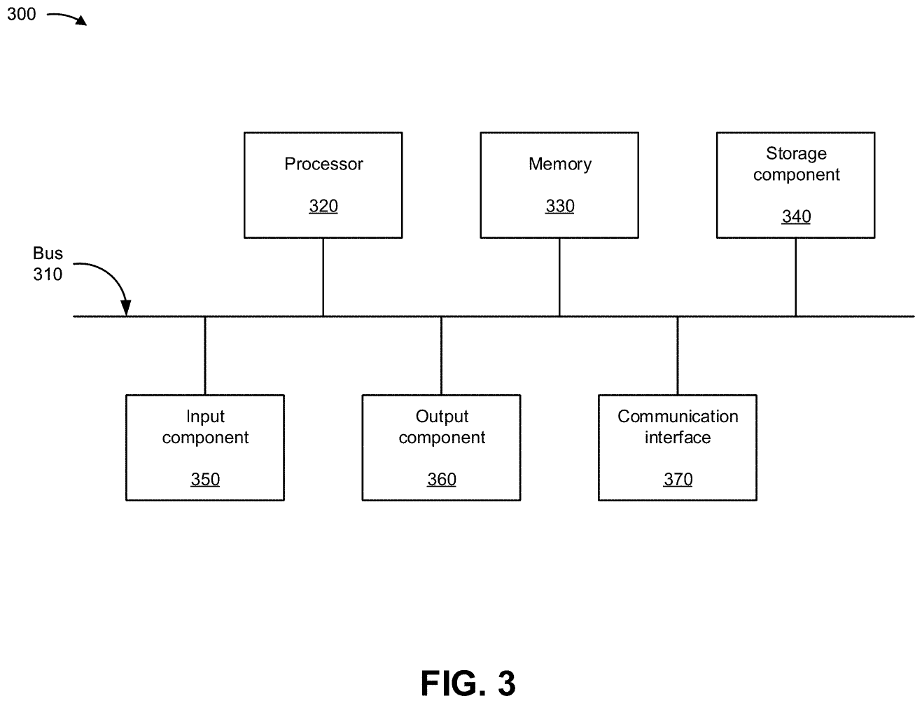

FIG. 3 is a diagram of example components of a device 300. Device 300 may correspond to user device 210, travel prediction platform 220, computing resource 224, server device 240, and/or transaction card 250. In some implementations, user device 210, travel prediction platform 220, computing resource 224, server device 240, and/or transaction card 250 may include one or more devices 300 and/or one or more components of device 300. As shown in FIG. 3, device 300 may include a bus 310, a processor 320, a memory 330, a storage component 340, an input component 350, an output component 360, and/or a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

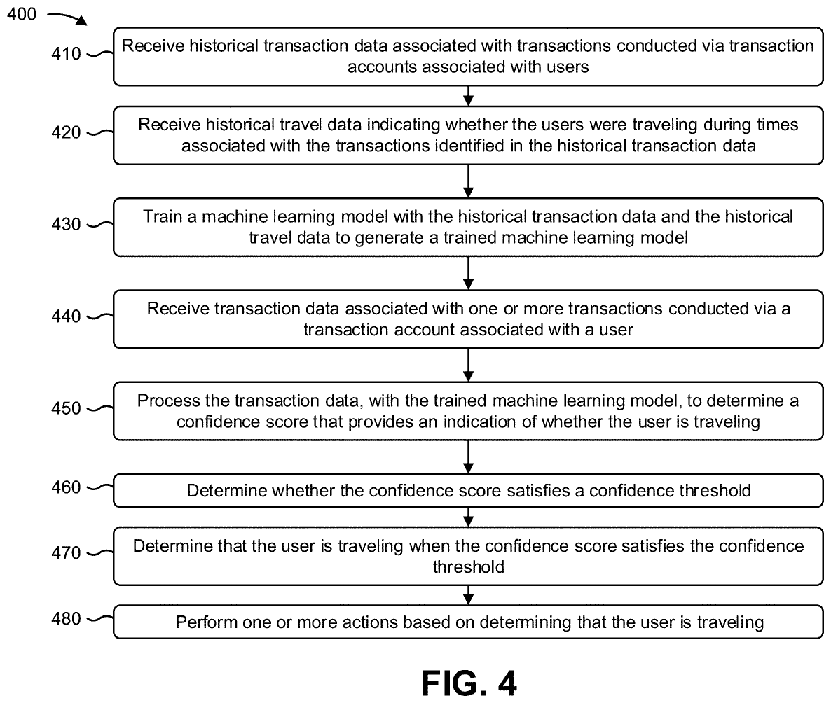

FIG. 4 is a flow chart of an example process 400 for utilizing a machine learning model to determine whether a transaction account user is traveling. In some implementations, one or more process blocks of FIG. 4 may be performed by a device (e.g., travel prediction platform 220). In some implementations, one or more process blocks of FIG. 4 may be performed by another device or a group of devices separate from or including the device, such as a user device (e.g., user device 210) and/or a server device (e.g., server device 240).

As shown in FIG. 4, process 400 may include receiving historical transaction data associated with transactions conducted via transaction accounts associated with users (block 410). For example, the device (e.g., using computing resource 224, processor 320, communication interface 370, and/or the like) may receive historical transaction data associated with transactions conducted via transaction accounts associated with users, as described above.

As further shown in FIG. 4, process 400 may include receiving historical travel data indicating whether the users were traveling during times associated with the transactions identified in the historical transaction data (block 420). For example, the device (e.g., using computing resource 224, processor 320, communication interface 370, and/or the like) may receive historical travel data indicating whether the users were traveling during times associated with the transactions identified in the historical transaction data, as described above.

As further shown in FIG. 4, process 400 may include training a machine learning model with the historical transaction data and the historical travel data to generate a trained machine learning model (block 430). For example, the device (e.g., using computing resource 224, processor 320, memory 330, and/or the like) may train a machine learning model with the historical transaction data and the historical travel data to generate a trained machine learning model, as described above.

As further shown in FIG. 4, process 400 may include receiving transaction data associated with one or more transactions conducted via a transaction account associated with a user (block 440). For example, the device (e.g., using computing resource 224, processor 320, input component 350, communication interface 370, and/or the like) may receive transaction data associated with one or more transactions conducted via a transaction account associated with a user, as described above.

As further shown in FIG. 4, process 400 may include processing the transaction data, with the trained machine learning model, to determine a confidence score that provides an indication of whether the user is traveling (block 450). For example, the device (e.g., using computing resource 224, processor 320, storage component 340, and/or the like) may process the transaction data, with the trained machine learning model, to determine a confidence score that provides an indication of whether the user is traveling, as described above.

As further shown in FIG. 4, process 400 may include determining whether the confidence score satisfies a confidence threshold (block 460). For example, the device (e.g., using computing resource 224, processor 320, memory 330, and/or the like) may determine whether the confidence score satisfies a confidence threshold, as described above.

As further shown in FIG. 4, process 400 may include determining that the user is traveling when the confidence score satisfies the confidence threshold (block 470). For example, the device (e.g., using computing resource 224, processor 320, storage component 340, and/or the like) may determine that the user is traveling when the confidence score satisfies the confidence threshold, as described above.

As further shown in FIG. 4, process 400 may include performing one or more actions based on determining that the user is traveling (block 480). For example, the device (e.g., using computing resource 224, processor 320, memory 330, storage component 340, communication interface 370, and/or the like) may perform one or more actions based on determining that the user is traveling, as described above.

Process 400 may include additional implementations, such as any single implementation or any combination of implementations described below and/or in connection with one or more other processes described elsewhere herein.

In a first implementation, process 400 may further include determining that the confidence score fails to satisfy the confidence threshold, providing, to a user device associated with the user, a notification requesting a response indicating whether the user is traveling, based on determining that the confidence score fails to satisfy the confidence threshold, and receiving, from the user device and based on the notification, the response indicating whether the user is traveling.

In a second implementation, alone or in combination with the first implementation, process 400 may further include determining that the user is traveling, when the response indicates that the user is traveling.

In a third implementation, alone or in combination with one or more of the first and second implementations, process 400 may further include determining that the user is not traveling, when the response indicates that the user is not traveling, and preventing activation of a travel indicator for the transaction account associated with the user, based on determining that the user is not traveling, where the travel indicator may indicate that the user is traveling.

In a fourth implementation, alone or in combination with one or more of the first through third implementations, performing the one or more actions may include process 400 activating a travel indicator for the transaction account associated with the user, where the travel indicator may indicate that the user is traveling, updating a fraud model to indicate that the user is traveling, or activating the travel indicator for one or more other accounts associated with the user.

In a fifth implementation, alone or in combination with one or more of the first through fourth implementations, performing the one or more actions may include process 400 maintaining a travel indicator for the transaction account for a predetermined time period, where the travel indicator may indicate that the user is traveling, maintaining a travel indicator for the transaction account until occurrence of a trigger event, or retraining the machine learning model based on determining that the user is traveling.

In a sixth implementation, alone or in combination with one or more of the first through fifth implementations, process 400 may further include determining that the confidence score fails to satisfy the confidence threshold, preventing activation of a travel indicator for the transaction account associated with the user, based on determining that the confidence score fails to satisfy the confidence threshold, where the travel indicator may indicate that the user is traveling.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

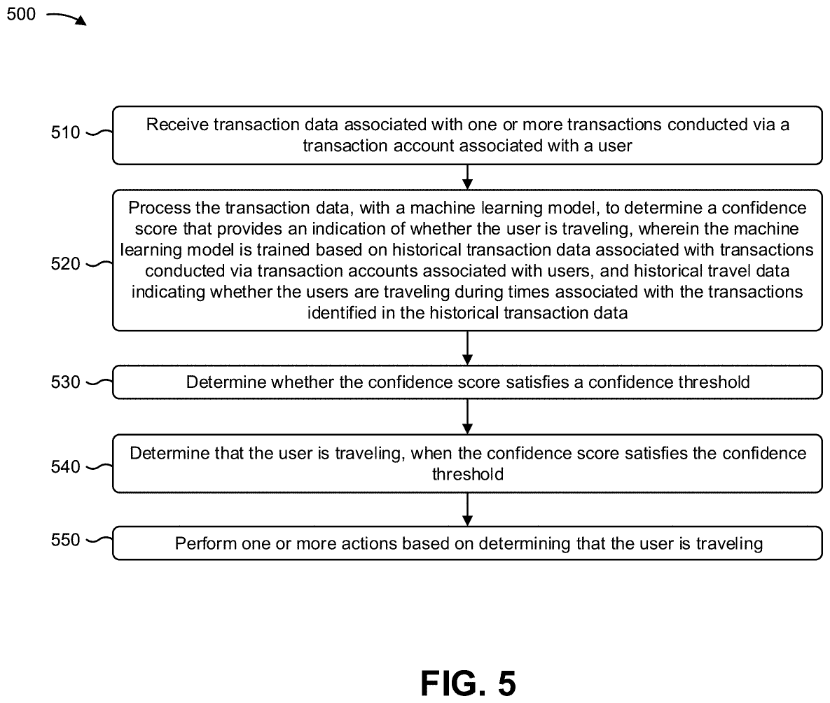

FIG. 5 is a flow chart of an example process 500 for utilizing a machine learning model to determine whether a transaction account user is traveling. In some implementations, one or more process blocks of FIG. 5 may be performed by a device (e.g., travel prediction platform 220). In some implementations, one or more process blocks of FIG. 5 may be performed by another device or a group of devices separate from or including the device, such as a user device (e.g., user device 210) and/or a server device (e.g., server device 240).

As shown in FIG. 5, process 500 may include receiving transaction data associated with one or more transactions conducted via a transaction account associated with a user (block 510). For example, the device (e.g., using computing resource 224, processor 320, communication interface 370, and/or the like) may receive transaction data associated with one or more transactions conducted via a transaction account associated with a user, as described above.

As further shown in FIG. 5, process 500 may include processing the transaction data, with a machine learning model, to determine a confidence score that provides an indication of whether the user is traveling, wherein the machine learning model is trained based on historical transaction data associated with transactions conducted via transaction accounts associated with users, and historical travel data indicating whether the users are traveling during times associated with the transactions identified in the historical transaction data (block 520). For example, the device (e.g., using computing resource 224, processor 320, memory 330, storage component 340, and/or the like) may process the transaction data, with a machine learning model, to determine a confidence score that provides an indication of whether the user is traveling, as described above. In some implementations, the machine learning model may be trained based on historical transaction data associated with transactions conducted via transaction accounts associated with users, and historical travel data indicating whether the users are traveling during times associated with the transactions identified in the historical transaction data.

As further shown in FIG. 5, process 500 may include determining whether the confidence score satisfies a confidence threshold (block 530). For example, the device (e.g., using computing resource 224, processor 320, memory 330, and/or the like) may determine whether the confidence score satisfies a confidence threshold, as described above.

As further shown in FIG. 5, process 500 may include determining that the user is traveling, when the confidence score satisfies the confidence threshold (block 540). For example, the device (e.g., using computing resource 224, processor 320, storage component 340, and/or the like) may determine that the user is traveling, when the confidence score satisfies the confidence threshold, as described above.

As further shown in FIG. 5, process 500 may include performing one or more actions based on determining that the user is traveling (block 550). For example, the device (e.g., using computing resource 224, processor 320, memory 330, storage component 340, communication interface 370, and/or the like) may perform one or more actions based on determining that the user is traveling, as described above.

Process 500 may include additional implementations, such as any single implementation or any combination of implementations described below and/or in connection with one or more other processes described elsewhere herein.

In a first implementation, the historical transaction data may include data identifying one or more of: one or more transactions associated with purchases at airports; one or more transactions associated with checking in at airports; one or more transactions associated with purchases at gas stations near an international border; one or more transactions associated with purchases at rest stops; one or more transactions associated with purchasing airline tickets; one or more transactions associated with withdrawing funds from automated teller machines located at airports or rest stops; one or more transactions associated with hotels; one or more transactions associated with wireless access purchases on airplanes; one or more transactions associated with currency exchange at airports; or one or more transactions associated with purchases of items at train stations.

In a second implementation, alone or in combination with the first implementation, the historical travel data may include data identifying one or more of airline travel itineraries associated with the users, train travel itineraries associated with the users, bus travel itineraries associated with the users, hotel accommodations associated with the users, or rental car agreements associated with the users.

In a third implementation, alone or in combination with one or more of the first and second implementations, performing the one or more actions may include process 500 activating a travel indicator for the transaction account associated with the user, where the travel indicator may indicate that the user is traveling, maintaining the travel indicator for a predetermined time period, and deactivating the travel indicator for the transaction account after the predetermined time period.

In a fourth implementation, alone or in combination with one or more of the first through third implementations, performing the one or more actions may include process 500 activating a travel indicator for the transaction account associated with the user, where the travel indicator may indicate that the user is traveling, maintaining the travel indicator until occurrence of a trigger event, where the trigger event may indicate that the user is not traveling, and deactivating the travel indicator for the transaction account after the occurrence of the trigger event.

In a fifth implementation, alone or in combination with one or more of the first through fourth implementations, performing the one or more actions may include process 500 activating a travel indicator for the transaction account associated with the user, where the travel indicator may indicate that the user is traveling, receiving additional transaction data indicating an additional transaction conducted via the transaction account associated with the user, and preventing a fraud model from preventing the additional transaction based on the travel indicator.

In a sixth implementation, alone or in combination with one or more of the first through fifth implementations, process 500 may further include determining that the confidence score fails to satisfy the confidence threshold, preventing activation of a travel indicator for the transaction account associated with the user based on determining that the confidence score fails to satisfy the confidence threshold, where the travel indicator may indicate that the user is traveling, receiving additional transaction data indicating an additional transaction conducted via the transaction account associated with the user, and preventing the additional transaction, via a fraud model, based on preventing activation of the travel indicator.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

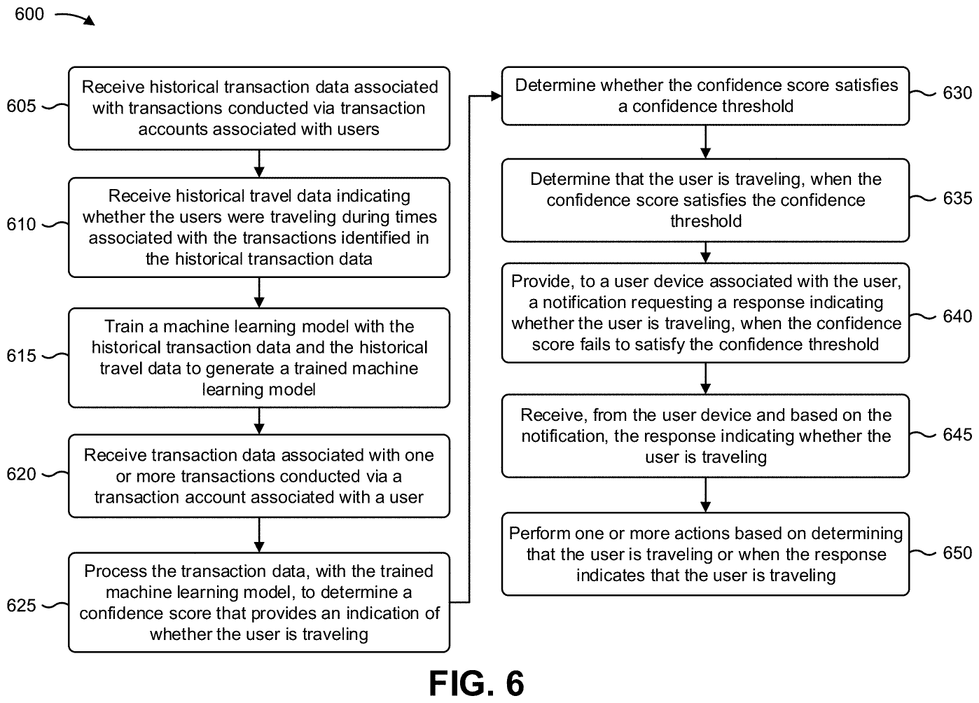

FIG. 6 is a flow chart of an example process 600 for utilizing a machine learning model to determine whether a transaction account user is traveling. In some implementations, one or more process blocks of FIG. 6 may be performed by a device (e.g., travel prediction platform 220). In some implementations, one or more process blocks of FIG. 6 may be performed by another device or a group of devices separate from or including the device, such as a user device (e.g., user device 210) and/or a server device (e.g., server device 240).

As shown in FIG. 6, process 600 may include receiving historical transaction data associated with transactions conducted via transaction accounts associated with users (block 605). For example, the device (e.g., using computing resource 224, processor 320, communication interface 370, and/or the like) may receive historical transaction data associated with transactions conducted via transaction accounts associated with users, as described above.

As further shown in FIG. 6, process 600 may include receiving historical travel data indicating whether the users were traveling during times associated with the transactions identified in the historical transaction data (block 610). For example, the device (e.g., using computing resource 224, processor 320, communication interface 370, and/or the like) may receive historical travel data indicating whether the users were traveling during times associated with the transactions identified in the historical transaction data, as described above.

As further shown in FIG. 6, process 600 may include training a machine learning model with the historical transaction data and the historical travel data to generate a trained machine learning model (block 615). For example, the device (e.g., using computing resource 224, processor 320, memory 330, and/or the like) may train a machine learning model with the historical transaction data and the historical travel data to generate a trained machine learning model, as described above.

As further shown in FIG. 6, process 600 may include receiving transaction data associated with one or more transactions conducted via a transaction account associated with a user (block 620). For example, the device (e.g., using computing resource 224, processor 320, communication interface 370, and/or the like) may receive transaction data associated with one or more transactions conducted via a transaction account associated with a user, as described above.

As further shown in FIG. 6, process 600 may include processing the transaction data, with the trained machine learning model, to determine a confidence score that provides an indication of whether the user is traveling (block 625). For example, the device (e.g., using computing resource 224, processor 320, memory 330, and/or the like) may process the transaction data, with the trained machine learning model, to determine a confidence score that provides an indication of whether the user is traveling, as described above.

As further shown in FIG. 6, process 600 may include determining whether the confidence score satisfies a confidence threshold (block 630). For example, the device (e.g., using computing resource 224, processor 320, storage component 340, and/or the like) may determine whether the confidence score satisfies a confidence threshold, as described above.

As further shown in FIG. 6, process 600 may include determining that the user is traveling, when the confidence score satisfies the confidence threshold (block 635). For example, the device (e.g., using computing resource 224, processor 320, memory 330, and/or the like) may determine that the user is traveling, when the confidence score satisfies the confidence threshold, as described above.

As further shown in FIG. 6, process 600 may include providing, to a user device associated with the user, a notification requesting a response indicating whether the user is traveling, when the confidence score fails to satisfy the confidence threshold (block 640). For example, the device (e.g., using computing resource 224, processor 320, memory 330, communication interface 370, and/or the like) may provide, to a user device associated with the user, a notification requesting a response indicating whether the user is traveling, when the confidence score fails to satisfy the confidence threshold, as described above.

As further shown in FIG. 6, process 600 may include receiving, from the user device and based on the notification, the response indicating whether the user is traveling (block 645). For example, the device (e.g., using computing resource 224, processor 320, communication interface 370, and/or the like) may receive, from the user device and based on the notification, the response indicating whether the user is traveling, as described above.

As further shown in FIG. 6, process 600 may include performing one or more actions based on determining that the user is traveling or when the response indicates that the user is traveling (block 650). For example, the device (e.g., using computing resource 224, processor 320, memory 330, storage component 340, communication interface 370, and/or the like) may perform one or more actions based on determining that the user is traveling or when the response indicates that the user is traveling, as described above.

Process 600 may include additional implementations, such as any single implementation or any combination of implementations described below and/or in connection with one or more other processes described elsewhere herein.

In a first implementation, process 600 may further include determining that the user is not traveling, when the response indicates that the user is not traveling, and preventing activation of a travel indicator for the transaction account associated with the user, based on determining that the user is not traveling, where the travel indicator may indicate that the user is traveling.

In a second implementation, alone or in combination with the first implementation, the one or more instructions, performing the one or more actions may include process 600 activating a travel indicator for the transaction account associated with the user, where the travel indicator may indicate that the user is traveling, updating a fraud model to indicate that the user is traveling, or activating the travel indicator for one or more other accounts associated with the user.

In a third implementation, alone or in combination with one or more of the first and second implementations, performing the one or more actions may include process 600 maintaining a travel indicator for the transaction account for a predetermined time period, where the travel indicator may indicate that the user is traveling, maintaining a travel indicator for the transaction account until occurrence of a trigger event, or retraining the machine learning model based on determining that the user is traveling.

In a fourth implementation, alone or in combination with one or more of the first through third implementations, performing the one or more actions may include process 600 activating a travel indicator for the transaction account associated with the user, where the travel indicator may indicate that the user is traveling, maintaining the travel indicator for a predetermined time period, and deactivating the travel indicator for the transaction account after the predetermined time period.

In a fifth implementation, alone or in combination with one or more of the first through fourth implementations, performing the one or more actions may include process 600 activating a travel indicator for the transaction account associated with the user, where the travel indicator may indicate that the user is traveling, maintaining the travel indicator until occurrence of a trigger event, where the trigger event may indicate that the user is not traveling, and deactivating the travel indicator for the transaction account after the occurrence of the trigger event.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method, comprising:
receiving, by a device, historical transaction data associated with transactions conducted via transaction accounts associated with users;
receiving, by the device, historical travel data indicating whether the users were traveling during times associated with the transactions identified in the historical transaction data,
wherein the historical transaction data includes data identifying one or more of:
one or more transactions associated with purchases at airports,
one or more transactions associated with checking in at airports,
one or more transactions associated with purchases at gas stations near an international border,
one or more transactions associated with purchases at rest stops,
one or more transactions associated with purchasing airline tickets,
one or more transactions associated with withdrawing funds from automated teller machines located at airports or rest stops,
one or more transactions associated with hotels,
one or more transactions associated with wireless access purchases on airplanes,
one or more transactions associated with currency exchange at airports, or
one or more transactions associated with purchases of items at train stations;
training, by the device, a machine learning model with the historical transaction data and the historical travel data to generate a trained machine learning model;
receiving, by the device, transaction data associated with one or more transactions conducted via a transaction account associated with a user;
processing, by the device, the transaction data, with the trained machine learning model, to determine a confidence score that provides an indication of whether the user is traveling,
wherein processing the transaction data comprises determining whether a transaction associated with the transaction data is a potential travel-related transaction based on at least one of:
whether the transaction occurs near a particular location frequented by the user, or
whether the transaction occurs nears a home associated with the user;
determining, by the device, whether the confidence score satisfies a confidence threshold;
determining, by the device, that the user is traveling when the confidence score satisfies the confidence threshold; and
performing, by the device, one or more actions based on determining whether the confidence score satisfies the confidence threshold,
wherein a first action, of the one or more actions, is performed based on the confidence score failing to satisfy the confidence threshold,
wherein the first action includes preventing activation of a travel indicator for the transaction account associated with the user, based on determining that the user is not traveling, or
wherein a second action, of the one or more actions, is performed based on the confidence score satisfying the confidence threshold,
wherein the second action includes activating the travel indicator for the transaction account associated with the user,
wherein the travel indicator indicates that the user is traveling.

2. The method of claim 1, further comprising:
determining that the confidence score fails to satisfy the confidence threshold;
providing, to a user device associated with the user, a notification requesting a response indicating whether the user is traveling, based on determining that the confidence score fails to satisfy the confidence threshold; and
receiving, from the user device and based on the notification, the response indicating whether the user is traveling.

3. The method of claim 2, further comprising:
determining that the user is traveling, when the response indicates that the user is traveling.

4. The method of claim 2, further comprising:
determining that the user is not traveling, when the response indicates that the user is not traveling.

5. The method of claim 1, wherein performing the one or more actions comprises one or more of:
updating a fraud model to indicate that the user is traveling; or
activating the travel indicator for one or more other accounts associated with the user.

6. The method of claim 1, wherein performing the one or more actions comprises one or more of:
maintaining the travel indicator for the transaction account for a predetermined time period;
maintaining the travel indicator for the transaction account until occurrence of a trigger event; or
retraining the machine learning model based on determining that the user is traveling.

7. The method of claim 1, further comprising:
determining that the confidence score fails to satisfy the confidence threshold; and
preventing activation of the travel indicator for the transaction account associated with the user, based on determining that the confidence score fails to satisfy the confidence threshold.

8. A device, comprising:
one or more memories; and
one or more processors, communicatively coupled to the one or more memories, configured to:
receive transaction data associated with one or more transactions conducted via a transaction account associated with a user;
process the transaction data, with a machine learning model, to determine a confidence score that provides an indication of whether the user is traveling,
wherein the machine learning model is trained based on:
historical transaction data associated with transactions conducted via transaction accounts associated with users, and
historical travel data indicating whether the users are traveling during times associated with the transactions identified in the historical transaction data,
wherein the historical transaction data includes data identifying one or more of:
one or more transactions associated with purchases at airports,
one or more transactions associated with checking in at airports,
one or more transactions associated with purchases at gas stations near an international border,
one or more transactions associated with purchases at rest stops,
one or more transactions associated with purchasing airline tickets,
one or more transactions associated with withdrawing funds from automated teller machines located at airports or rest stops,
one or more transactions associated with hotels,
one or more transactions associated with wireless access purchases on airplanes,
one or more transactions associated with currency exchange at airports, or
one or more transactions associated with purchases of items at train stations;
determine whether the confidence score satisfies a confidence threshold;
determine that the user is traveling, when the confidence score satisfies the confidence threshold,
wherein the one or more processors, when processing the transaction data, are to determine whether a transaction associated with the transaction data is a potential travel-related transaction based on at least one of:
whether the transaction occurs near a particular location frequented by the user, or
whether the transaction occurs nears a home associated with the user; and
perform one or more actions based on determining that the user is traveling,
wherein a first action, of the one or more actions, is performed based on the confidence score failing to satisfy the confidence threshold,
wherein the first action includes preventing activation of a travel indicator for the transaction account associated with the user, based on determining that the user is not traveling, or
wherein a second action, of the one or more actions, is performed based on the confidence score satisfying the confidence threshold,
wherein the second action includes activating the travel indicator for the transaction account associated with the user,
wherein the travel indicator indicates that the user is traveling.

9. (canceled)

10. The device of claim 8, wherein the historical travel data includes data identifying one or more of:
airline travel itineraries associated with the users,
train travel itineraries associated with the users,
bus travel itineraries associated with the users,
hotel accommodations associated with the users, or
rental car agreements associated with the users.

11. The device of claim 8, wherein the one or more processors, when performing the one or more actions, are configured to one or more of:
maintain the travel indicator for a predetermined time period; and
deactivate the travel indicator for the transaction account after the predetermined time period.

12. The device of claim 8, wherein the one or more processors, when performing the one or more actions, are configured to one or more of:
maintain the travel indicator until occurrence of a trigger event,
wherein the trigger event indicates that the user is not traveling; and
deactivate the travel indicator for the transaction account after the occurrence of the trigger event.

13. The device of claim 8, wherein the one or more processors, when performing the one or more actions, are configured to one or more of:
receive additional transaction data indicating an additional transaction conducted via the transaction account associated with the user; and
prevent a fraud model from preventing the additional transaction based on the travel indicator.

14. The device of claim 8, wherein the one or more processors are further configured to:
determine that the confidence score fails to satisfy the confidence threshold;
receive additional transaction data indicating an additional transaction conducted via the transaction account associated with the user; and
prevent the additional transaction, via a fraud model, based on preventing activation of the travel indicator.

15. A non-transitory computer-readable medium storing instructions, the instructions comprising:
one or more instructions that, when executed by one or more processors, cause the one or more processors to:
receive historical transaction data associated with transactions conducted via transaction accounts associated with users;
receive historical travel data indicating whether the users were traveling during times associated with the transactions identified in the historical transaction data,
wherein the historical transaction data includes data identifying one or more of:
one or more transactions associated with purchases at airports,
one or more transactions associated with checking in at airports,
one or more transactions associated with purchases at gas stations near an international border,
one or more transactions associated with purchases at rest stops,
one or more transactions associated with purchasing airline tickets,
one or more transactions associated with withdrawing funds from automated teller machines located at airports or rest stops,
one or more transactions associated with hotels,
one or more transactions associated with wireless access purchases on airplanes,
one or more transactions associated with currency exchange at airports, or
one or more transactions associated with purchases of items at train stations;
train a machine learning model with the historical transaction data and the historical travel data to generate a trained machine learning model;
receive transaction data associated with one or more transactions conducted via a transaction account associated with a user;
process the transaction data, with the trained machine learning model, to determine a confidence score that provides an indication of whether the user is traveling;
determine whether the confidence score satisfies a confidence threshold;
determine that the user is traveling, when the confidence score satisfies the confidence threshold,
wherein the one or more instructions, that cause the one or more processors to process the transaction data, cause the one or more processors to determine whether a transaction associated with the transaction data is a potential travel-related transaction based on at least one of:
whether the transaction occurs near a particular location frequented by the user, or
whether the transaction occurs nears a home associated with the user;
provide, to a user device associated with the user, a notification requesting a response indicating whether the user is traveling, when the confidence score fails to satisfy the confidence threshold;
receive, from the user device and based on the notification, the response indicating whether the user is traveling; and
perform one or more actions based on determining that the user is traveling or when the response indicates that the user is traveling,
wherein one or more actions includes preventing activation of a travel indicator for the transaction account associated with the user.

16. The non-transitory computer-readable medium of claim 15, wherein the instructions further comprise:
one or more instructions that, when executed by the one or more processors, cause the one or more processors to:
determine that the user is not traveling, when the response indicates that the user is not traveling.

17. The non-transitory computer-readable medium of claim 15, wherein the one or more instructions, that cause the one or more processors to perform the one or more actions, cause the one or more processors to one or more of:
update a fraud model to indicate that the user is traveling; or
activate the travel indicator for one or more other accounts associated with the user.

18. The non-transitory computer-readable medium of claim 15, wherein the one or more instructions, that cause the one or more processors to perform the one or more actions, cause the one or more processors to one or more of:
maintain the travel indicator for the transaction account for a predetermined time period;
maintain the travel indicator for the transaction account until occurrence of a trigger event; or
retrain the machine learning model based on determining that the user is traveling.

19. The non-transitory computer-readable medium of claim 15, wherein the one or more instructions, that cause the one or more processors to perform the one or more actions, cause the one or more processors to one or more of:
maintain the travel indicator for a predetermined time period; and
deactivate the travel indicator for the transaction account after the predetermined time period.

20. The non-transitory computer-readable medium of claim 15, wherein the one or more instructions, that cause the one or more processors to perform the one or more actions, cause the one or more processors to one or more of:
maintain the travel indicator until occurrence of a trigger event,
wherein the trigger event indicates that the user is not traveling; and
deactivate the travel indicator for the transaction account after the occurrence of the trigger event.

21. The device of claim 8, wherein the one or more processors are further to:
determine that the confidence score fails to satisfy the confidence threshold; and
decline the one or more transactions based on determining that the confidence score fails to satisfy the confidence threshold.
